(19) United States
(12) Patent Application Publication
(10) Pub. No.: US 2022/0240089 A1
(43) Pub. Date: Jul. 28, 2022

(54) AUTHORIZATION FOR NETWORK FUNCTION SETS IN COMMUNICATION SYSTEM

(71) Applicant: Nokia Technologies Oy, Espoo (FI)

(72) Inventors: Nagendra BYKAMPADI, Bangalore (IN); Suresh NAIR, Whippany, NJ (US); Anja JERICHOW, Grafing bei München (DE)

(21) Appl. No.: 17/618,846

(22) PCT Filed: Jun. 4, 2020
(86) PCT No.: PCT/IB2020/055285

§ 371 Date: Dec. 13, 2021

(30) Foreign Application Priority Data
Jun. 15, 2019 (IN) 201941023834

(51) Int. Cl. H04W 12/08; H04W 12/06

(52) U.S. Cl. CPC H04W 12/08; H04W 12/06

(57) ABSTRACT

Improved techniques for secure access control in communication systems are provided. Secure access control in one or more examples includes authorization of network function sets. For example, in accordance with an authorization server function, a method includes receiving a request from a service consumer in a communication system for access to a service type, wherein the request comprises information including a service producer set identifier. The method determines whether the service consumer is authorized to access the service type. The method identifies service producer instances that belong to the requested service producer set identifier. The method generates an access token that comprises identifiers for identified ones of the service producer instances that belong to the requested service producer set identifier, and sends the access token to the service consumer.

### FIELD

The field relates generally to communication systems, and more particularly, but not exclusively, to secure access control within such systems.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB or N3IWF or TNGF or W-AGF depending on the type of 5G Access Network: supporting NR radio defined by 3GPP, supporting an Untrusted Non 3GPP access to SGC, supporting a Trusted Non 3GPP access to 5GC (5G Core) or supporting a Wireline access to 5GC) is illustratively part of an access network of the communication system. For example, in a 5G network, the access network referred to as a 5G AN is described in 5G Technical Specification (TS) 23.501, V16.0.2, entitled “Technical Specification Group Services and System Aspects; System Architecture for the 5G System,” the disclosure of which is incorporated by reference herein in its entirety. In general, the access point (e.g., gNB or N3IWF or TNGF or W-AGF depending on the type of 5G Access Network) provides access for the UE to a core network (CN or 5GC), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, V15.4.0, entitled “Technical Specification Group Services and System Aspects; Security Architecture and Procedures for the 5G System,” the disclosure of which is incorporated by reference herein in its entirety, further describes security management details associated with a 5G network.

Access of network entities is an important security management consideration in any communication system. However, secure access (e.g., via authorization) in certain circumstances presents several challenges.

### SUMMARY

Illustrative embodiments provide improved techniques for secure access control in communication systems. For example, secure access control in one or more illustrative embodiments comprises authorization of network function sets.

For example, in one illustrative embodiment in accordance with an authorization server function, a method comprises receiving a request from a service consumer in a communication system for access to a service type, wherein the request comprises information including a service producer set identifier. The method determines whether the service consumer is authorized to access the service type. The method identifies service producer instances that belong to the requested service producer set identifier. The method generates an access token that comprises identifiers for identified ones of the service producer instances that belong to the requested service producer set identifier, and sends the access token to the service consumer.

In another illustrative embodiment in accordance with a service consumer, a method comprises sending a request to an authorization server function in a communication system for access to a service type, wherein the request comprises information including a service producer set identifier. The method receives an access token that comprises identifiers for identified ones of service producer instances that belong to the requested service producer set identifier. The method uses the access token to access one of the service producer instances identified in the access token.

In illustrative embodiments, the service consumer is a network function (NF) and the authorization server function is a network repository function (NRF) in a 5G System. In such embodiments, the service producer may belong to a set of similar network functions, identified by a set identifier, NF Set ID. Also, a pre-selection of identified ones of the service producer instances can be performed at the NRF for inclusion in the access token, or selection can be performed at the NF consumer.

Further illustrative embodiments are provided in the form of a non-transitory computer-readable storage medium having embodied therein executable program code that when executed by a processor causes the processor to perform the above steps. Still further illustrative embodiments comprise apparatus with a processor and a memory configured to perform the above steps. Also, methods, non-transitory computer-readable storage media, and apparatus from the perspective of the service consumer are provided in other embodiments.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments are implemented.

FIG. 2 illustrates processing architectures for network entities involved in secure access control in a communication system, according to an illustrative embodiment.

FIG. 3 illustrates a message flow for an access token request methodology in a communication system, according to an illustrative embodiment.

FIG. 4 illustrates part of an access token to specify multiple service producer instances, according to an illustrative embodiment.

FIG. 5 illustrates a message flow for an access token request methodology in a communication system, according to another illustrative embodiment.

FIG. 6 illustrates a table of access token claim types, according to an illustrative embodiment.

FIG. 7 illustrates a table of audience claim types, according to an illustrative embodiment.

### DETAILED DESCRIPTION

Embodiments will be illustrated herein in conjunction with example communication systems and associated techniques for providing secure access control of network entities in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) provide further explanation of user equipment and network elements/functions and/or operations that interact with one or more illustrative embodiments, e.g., the above-referenced 3GPP TS 23.501 and 3GPP TS 33.501. Other 3GPP TS/TR documents provide other conventional details that one of ordinary skill in the art will realize. For example, 3GPP TS 23.502, V16.0.2, entitled “Technical Specification Group Services and System Aspects; Procedures for the 5G System; Stage 2,” as well as in 3GPP TS 29.510, V15.3.0, entitled “Technical Specification Group Core Network and Terminals; 5G System; Network Function Repository Services,” the disclosures of which are incorporated by reference herein in their entireties, will be referenced below. However, while illustrative embodiments are well-suited for implementation associated with the above-mentioned 5G-related 3GPP standards, alternative embodiments are not necessarily intended to be limited to any particular standards.

Furthermore, illustrative embodiments will be explained herein in the context of the Open Systems Interconnection model (OSI model) which is a model that conceptually characterizes communication functions of a communication system such as, for example, a 5G network. The OSI model is typically conceptualized as a hierarchical stack with a given layer serving the layer above and being served by the layer below. Typically, the OSI model comprises seven layers with the top layer of the stack being the application layer (layer 7) followed by the presentation layer (layer 6), the session layer (layer 5), the transport layer (layer 4), the network layer (layer 3), the data link layer (layer 2), and the physical layer (layer 1). One of ordinary skill in the art will appreciate the functions and interworkings of the various layers and, thus, further details of each layer are not described herein. However, it is to be appreciated that while illustrative embodiments are well-suited for implementations that utilize an OSI model, alternative embodiments are not necessarily limited to any particular communication function model.

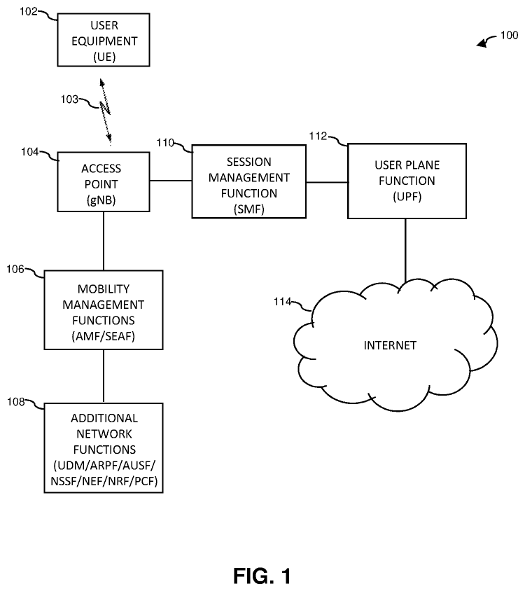

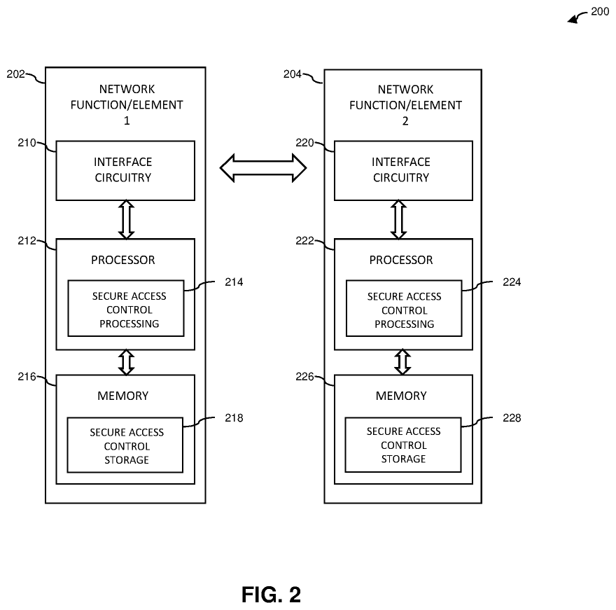

Illustrative embodiments are related to key management associated with the Service-Based Architecture (SBA) for 5G networks. Prior to describing such illustrative embodiments, a general description of main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used in other embodiments to implement some or all of the main functions represented. Also, it is to be understood that not all functions of a 5G network are depicted in FIG. 1. Rather, functions that facilitate an explanation of illustrative embodiments are represented. Subsequent figures may depict some additional elements/functions.

Accordingly, as shown, communication system 100 comprises user equipment (UE) 102 that communicates via an air interface 103 with an access point 104 (gNB or N3IWF or TNGF or W-AGF depending on the type of 5G Access Network). The UE 102 in some embodiments is a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone or other cellular device. In one or more illustrative embodiments, user equipment refers to an IoT device. Such communication devices are also intended to encompass devices commonly referred to as access terminals. In other embodiments, the UE could be hosted by a Residential Gateway connected to 5G Core via Wireline access.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the permanent subscription identifier and its related key, which are used to identify and authenticate subscribers to access networks. The ME is the user-independent part of the UE and contains terminal equipment (TE) functions and various mobile termination (MT) functions.

Note that, in one example, the permanent subscription identifier is an International Mobile Subscriber Identity (IMSI) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as a Subscription Concealed Identifier (SUCI).

The access point 104 is illustratively part of an access network of the communication system 100. Such an access network comprises, for example, a 5G System having a plurality of base stations and one or more associated radio network control functions. The base stations and radio network control functions in some embodiments are logically separate entities, but in some embodiments are implemented in the same physical network element, such as, for example, a base station router or cellular access point.

The access point 104 in this illustrative embodiment is operatively coupled to mobility management functions 106. In a 5G network, the mobility management function is implemented by an Access and Mobility Management Function (AMF). A Security Anchor Function (SEAF) in some embodiments is also implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF is also referred to herein, more generally, as an access and mobility management entity.

The AMF 106 in this illustrative embodiment is operatively coupled to additional network functions 108, e.g., one or more functions that are resident in the home network of the subscriber or elsewhere. Some of these functions include the Unified Data Management (UDM) function, as well as an Authentication Server Function (AUSF). The AUSF and UDM (separately or collectively) are also referred to herein, more generally, as an authentication entity. The UDM supports an Authentication Credential Repository and Processing Function (ARPF) which typically stores long-term security credentials used in authentication. In addition, subscriber functions include, but are not limited to, Network Slice Selection Function (NSSF), Network Exposure Function (NEF), Network Repository Function (NRF), and Policy Control Function (PCF).

In illustrative embodiments, the subscriber of the UE maintains a mobile subscription with the operator of the core network or another mobile network. Note that a UE is typically subscribed to what is referred to as a Home Public Land Mobile Network (HPLMN) in which some or all of the subscriber functions reside. If the UE is roaming (not in the HPLMN), it is typically connected with a Visited Public Land Mobile Network (VPLMN) also referred to as a serving network. Some or all of the mobility management functions 106 may reside in the VPLMN, in which case, functions in the VPLMN communicate with functions in the HPLMN as needed. However, in a non-roaming scenario, mobility management functions 106 and additional network functions 108 can reside in the same communication network or elsewhere as needed.

The access point 104 is also operatively coupled to a serving gateway function, i.e., Session Management Function (SMF) 110, which is operatively coupled to a User Plane Function (UPF) 112. UPF 112 is operatively coupled to a Packet Data Network, e.g., Internet 114. As is known in 5G and other communication networks, the user plane (UP) or data plane carries network user traffic while the control plane (CP) carries signaling traffic. SMF 110 supports functionalities relating to UP subscriber sessions, e.g., establishment, modification and release of PDU sessions. UPF 112 supports functionalities to facilitate UP operations, e.g., packet routing and forwarding, interconnection to the data network (e.g., 114 in FIG. 1), policy enforcement, and data buffering.

It is to be appreciated that FIG. 1 is a simplified illustration in that not all communication links and connections between network functions (NFs) and other system elements are illustrated in FIG. 1. One ordinarily skilled in the art given the various 3GPP TSs/TRs will appreciate the various links and connections not expressly shown or that may otherwise be generalized in FIG. 1.

Further typical operations and functions of certain network elements are not described herein in detail when they are not the focus of illustrative embodiments but can be found in appropriate 3GPP 5G documentation. It is to be appreciated that the particular arrangement of system elements in FIG. 1 is an example only, and other types and arrangements of additional or alternative elements can be used to implement a communication system in other embodiments. For example, in other embodiments, the system 100 comprises other elements/functions not expressly shown herein. Also, although only single elements/functions are shown in the FIG. 1 embodiment, this is for simplicity and clarity of illustration only. A given alternative embodiment may include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of network function (NF) sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via access point 104 (gNB or N3IWF or TNGF or W-AGF depending on the type of 5G Access Network). NFs can also access services of other NFs.

FIG. 2 is a block diagram of processing architectures 200 of two components (e.g., network entities which can include network functions and other network elements of the communication system) involved in secure access control in a communication system in an illustrative embodiment. It is to be appreciated that more than two components may be involved in secure access control according to illustrative embodiments. As such, FIG. 2 illustrates processing architectures associated with any two of the components that directly or indirectly communicate. Therefore, in illustrative embodiments, each participant in a secure access control methodology is understood to be configured with the processing architecture shown in FIG. 2.

As shown, a network function/element 202 comprises a processor 212 coupled to a memory 216 and interface circuitry 210. The processor 212 of the network function/element 202 includes a secure access control processing module 214 that may be implemented at least in part in the form of software executed by the processor. The processing module 214 performs secure access control described in conjunction with subsequent figures and otherwise herein. The memory 216 of the network function/element 202 includes a secure access control storage module 218 that stores data generated or otherwise used during secure access control operations.

As further shown, a network function/element 204 comprises a processor 222 coupled to a memory 226 and interface circuitry 220. The processor 222 of the network function/element 204 includes a secure access control processing module 224 that may be implemented at least in part in the form of software executed by the processor 222. The processing module 224 performs secure access control described in conjunction with subsequent figures and otherwise herein. The memory 226 of the network function/element 204 includes a secure access control storage module 228 that stores data generated or otherwise used during secure access control operations.

The processors 212 and 222 of the respective components 202 and 204 may comprise, for example, microprocessors, application-specific integrated circuits (ASICs), field programmable gate arrays (FPGAs), digital signal processors (DSPs) or other types of processing devices or integrated circuits, as well as portions or combinations of such elements. Such integrated circuit devices, as well as portions or combinations thereof, are examples of “circuitry” as that term is used herein. A wide variety of other arrangements of hardware and associated software or firmware may be used in implementing the illustrative embodiments.

The memories 216 and 226 of the respective components 202 and 204 may be used to store one or more software programs that are executed by the respective processors 212 and 222 to implement at least a portion of the functionality described herein. For example, secure access control operations and other functionality as described in conjunction with subsequent figures and otherwise herein may be implemented in a straightforward manner using software code executed by processors 212 and 222.

A given one of the memories 216 or 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

The memory 216 or 226 may more particularly comprise, for example, an electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 of the respective components 202 and 204 illustratively comprise transceivers or other communication hardware or firmware that allows the associated system elements to communicate with one another in the manner described herein.

It is apparent from FIG. 2 that the network function/element 202 is configured for communication with the network function/element 204 and vice-versa via their respective interface circuitries 210 and 220. This communication involves the network function/element 202 sending data to the network function/element 204, and the network function/element 204 sending data to the network function/element 202. However, in alternative embodiments, other network elements or other components may be operatively coupled between, as well as to, the components 202 and 204. The term “data” as used herein is intended to be construed broadly, so as to encompass any type of information that may be sent between components including, but not limited to, messages, tokens, identifiers, keys, indicators, user data, control data, authentication data, etc.

It is to be appreciated that the particular arrangement of components shown in FIG. 2 is an example only, and numerous alternative configurations are used in other embodiments. For example, any given network element/function can be configured to incorporate additional or alternative components and to support other communication protocols.

In illustrative embodiments, as will be further explained below, the network function/element 202 is an NF such as a UDM, PCF or NEF, and the network function/element 204 is an NF such as an NRF (authorization server). Further, one or both of the first network element/function 202 and the second network element/function 204 may also represent a Service Communication Proxy (SCP) element. 3GPP Release 16 of TS 23.501 introduces what is referred to as an indirect communication model in which network functions (NFs) communicate via a SCP, which is an intermediate NF configured to route control plane messages between two NFs (e.g., in a manner similar to that of a Diameter Routing Agent (DRA) in a 3G or 4G communication system).

Given the above illustrative architectures, illustrative embodiments of secure access control (e.g., via authorization) between one or more NFs will be further described below. Prior to such descriptions, some main drawbacks that at least partially motivated development of illustrative embodiments will be described in the context of a 5G network.

While two NFs that need to communicate (e.g., one NF gains access to another NF's service(s)) can be in different PLMNs, some NFs in the same PLMN also have a need to communicate. In either scenario (inter-PLMN communication or intra-PLMN communication), the SBA communication model includes security methods that enable an “NF service consumer” or “NF consumer” (service client) to be authenticated and authorized to access a service provided by or otherwise associated with an “NF service producer” or “NF producer” (service server). One of the supported authorization methods in the above-referenced 3GPP TS 33.501 (Release 15) is based on the OAuth 2.0 (referred to simply herein as “OAuth”) access token methodology. In a 5G system, the following model is adopted when OAuth is used: (i) the NRF is the OAuth authorization server; (ii) the NF service consumer is the OAuth client; and (iii) the NF service producer is the OAuth resource server.

The NF service consumer (client) discovers the NF service producer (resource server) via the NRF, and then obtains an access token to present to the NF service producer when invoking the service application programming interface (API) request.

In 3GPP Rel-16, network reliability is introduced via the concept of “NF Sets” and “NF Service Sets.”

An NF Set is used to manage the scalability and load sharing/management of the NF, thus allowing reliability of NF instances within the same NF Set. When the selected NF producer instance is not available, another NF producer instance within the same NF Set is selected.

When NF Service Sets are used, this allows reliability of NF Services within the NF Service Set. When multiple NF Service instances within a NF Service Set are exposed to the NF service consumer or a SCP and a failure of a given NF service instance is detected or notified by the NRF (e.g., the given NF service instance is not available anymore), the NF service consumer or SCP selects another NF service instance of the same NF Service Set within the NF instance, if available. Otherwise, the NF service consumer or SCP selects a different NF instance within the same NF Set.

The NF service consumer includes NF Set ID or NF Service Set ID in the discovery request if the target NF producer or service is needed within a Set. The NRF picks producers or services within the request set.

In 3GPP Rel-15, an access token is obtained either for the selected NF producer or a group of NF producers of a certain type. There is no option to obtain a single access token that allows to take advantage of the NF reliability enhancements in Rel-16. In other words, there is currently no network mechanism to generate an access token that can be used for all the members of the NF/NF Services set. Rather, an existing proposal in 3GPP TDoc—S3-191674, the disclosure of which is incorporated by reference herein in its entirety, requires the NRF to deduce the NF Set Id and include it as one of claims in the access token.

Illustrative embodiments overcome the above and other drawbacks associated with existing proposals network reliability proposals utilizing the concept of NF Sets and NF Service Sets.

For example, one or more illustrative embodiments provide for the following:

a) The NF service consumer includes a target NF Set ID in the Access Token Request message to the NRF.

b) The NRF identifies all the NF Producers that belong to the requested NF Set ID.

c) The NRF selects eligible NF Producers that may be sent to the NF service consumer. This is based on a number of factors such as, e.g.:
Information of the UE with which the request is associated, such as its location. This may be based on the UE Internet Protocol (IP) address.
Information of the requesting NF consumer such as its location, e.g., identified by its IP address.
When the processing load of a candidate NF producer has crossed a certain threshold limit. In other words, the load has reached the overload condition already.

In one or more illustrative embodiments, final selection is performed by the NF service consumer or SCP. Illustrative embodiments propose a first round of selection at the NRF to remove NF producers from the list of NF producers available for the NF consumer to select, based on readily-available factors such as location of the UE, location of the NF consumer, whether the load on the NF producer has crossed the overload threshold limit, etc. In other words, the NRF is limiting the potential list of NF producer instances based on several factors and forms an “audience” claim in the access token.

d) The NRF populates the audience claim in the access token with the NF Instance ID(s) of all the selected NF producer instances.

In an alternative to step (c) above, the NRF enhances the audience claim to include the NF Set ID. With this approach, the responsibility of selecting the correct NF producer instance lies with NF consumer or the SCP. With this option, a first round of selection in the NRF is not performed as the onus of selecting NF producers now falls completely in the context of the NF consumer.

The NF consumer uses the access token to access one of the service producer instances identified in the access token (e.g., sends the access token to the instance).

A proposed format for the access token and message flows associated therewith, according to one or more illustrative embodiment, will be described below in multiple parts.

Part 1: Include NF Set ID in the Access Token Request message

In the Access Token Request (i.e., Nnrf_AccessToken_Get), the NF service consumer includes the NF Set ID of the target NF producer.

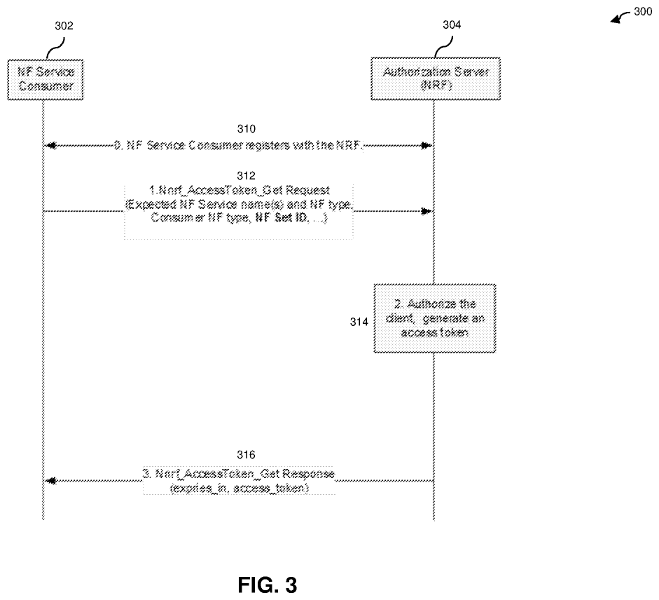

FIG. 3 illustrates a message flow 300 for an access token request methodology in a communication system, according to an illustrative embodiment. The figure is adapted from TS 33.501. More particularly, as will be explained, the NF service consumer 302 includes the NF Set ID of the target NF producer in the request to NRF 304.

As shown, in step 310, NF Service Consumer 302 registers with NRF 304 (authorization server).

In step 312, NF Service Consumer 304 sends an access token request to NRF 304. As shown, the access token request includes the Expected NF Service name(s), NF type, Consumer NF type, and NF Set ID.

In step 314, NRF 304 authorizes the client and generates an access token.

In step 316, NRF 304 sends an access token response (i.e., Nnrf_AccessToken_Get Response) to NF Service Consumer 302. Note that in illustrative embodiments, an access token has an expiration time associated therewith. Also, in illustrative embodiments, note that the requesting NF Service Consumer's NF Instance Id is added to the access token (e.g., in the subject field).

Part 2: NRF determines all the NF producers and populates the access token

The NRF identifies all the NF producers which belong to the requested NF Set ID.

The NRF performs a first round of selection based on multiple criteria including, for example:
Information of the UE such as its location. This may be based on the UE IP address.
Information of the requesting NF consumer such as its location, e.g., identified by its IP address.
When the processing load of a candidate NF producer has crossed the overload threshold limit. In other words, the load has reached the overload condition already.

The NRF then populates the audience claim in the access token with the NF Instance ID(s) of all the selected NF producer instances.

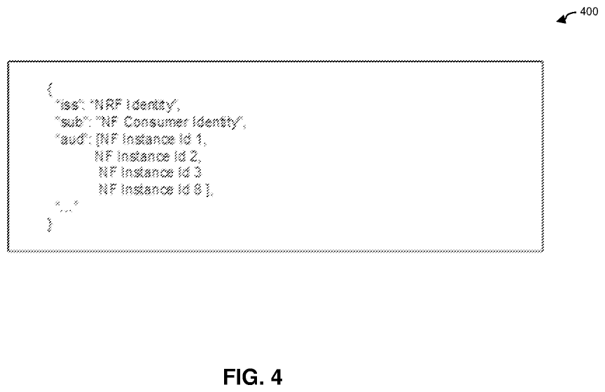

FIG. 4 includes an example 400 that shows how the audience claim is used to capture addresses of the discovered NF producer instances. Note that in one or more embodiments, the access token is a JavaScript Object Notation (JSON) Web Token.

In the embodiment shown in FIG. 4, the audience claim is an array with each element of the array consisting of the NF Instance Id of all the identified NF producer instances.

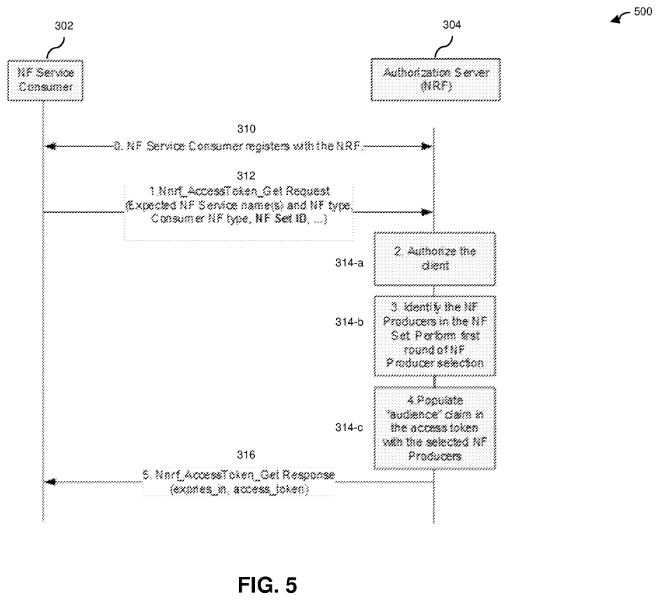

FIG. 5 illustrates a message flow 500 that extends the message flow 300 described above in FIG. 3 with enhanced functionality in the NRF 304 to identify, select NF producers and populate their NF Instance IDs in the access token. Thus, steps 310, 312 and 316 are the same as in FIG. 3. However, in the message flow 500 in FIG. 5, NRF 304 authorizes the client in step 314-a. In step 314-b, NRF 304 identifies the NF producers in the NF Set and performs the first round of NF producer selection. In step 314-c, NRF 304 populates the audience claim in the access token with the selected NF producers.

Part 3: NF includes NF Set ID in the audience claim

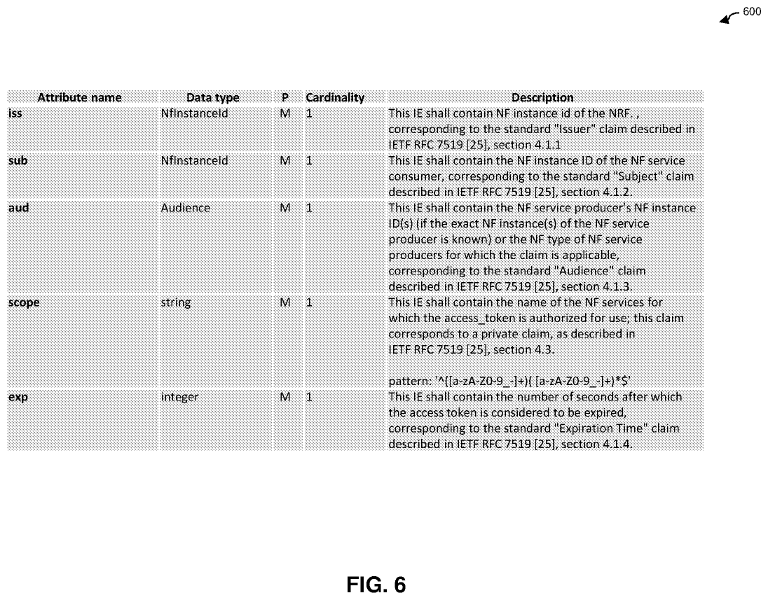

An alternate to Part 2 is that the NRF may just include the NF Set ID in the access token. In one illustrative embodiment, NF Set ID may be included in the “audience field” of the access token. 3GPP TS 29.510 defines stage 3 details for the access token. FIG. 6 shows table 600 which provides definitions of the access token claim types.

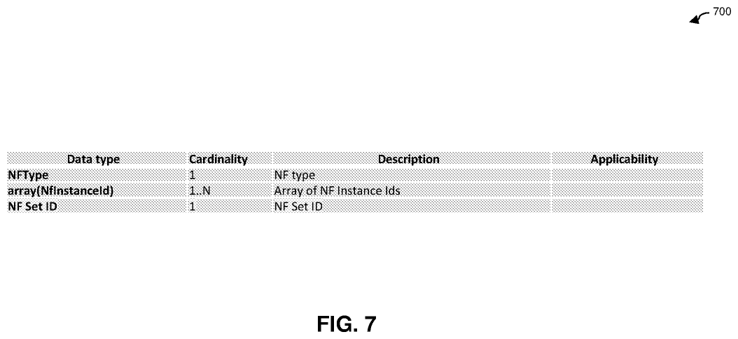

3GPP TS 29.510 defines “audience” as a list which includes NF Type or array of NF Instance Ids. The addition of an NF Set ID data type is shown in table 700 of FIG. 7. Note also that while the authentication server function is depicted as part of the NRF in various illustrative embodiments, the authentication server function can be part of any NF in alternative embodiments.

The particular processing operations and other system functionality described in conjunction with FIGS. 1-7 are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should therefore again be emphasized that the various embodiments described herein are presented by way of illustrative example only and should not be construed as limiting the scope of the claims. For example, alternative embodiments can utilize different communication system configurations, user equipment configurations, base station configurations, authentication and key agreement protocols, key pair provisioning and usage processes, messaging protocols and message formats than those described above in the context of the illustrative embodiments. These and numerous other alternative embodiments within the scope of the appended claims will be readily apparent to those skilled in the art.

1-24. (canceled)

25. Apparatus comprising:
at least one processor;
at least one memory including computer program code;
the at least one memory and the computer program code being configured to, with the at least one processor, cause the apparatus at least to:
receive a request from a service consumer in a communication system for access to a service type, wherein the request comprises information including a service producer set identifier;
determine whether the service consumer is authorized to access the service type;
identify service producer instances that belong to the requested service producer set identifier;
generate an access token that comprises identifiers for identified ones of the service producer instances that belong to the requested service producer set identifier; and
send the access token to the service consumer;
wherein the at least one processor, the at least one memory and the computer program code are part of an authorization server function in the communication system.

26. The apparatus of claim 25, wherein the at least one memory and the computer program code being further configured to, with the at least one processor, cause the apparatus to select a subset of identified ones of the service producer instances that belong to the requested service producer set identifier for inclusion in the access token.

27. The apparatus of claim 26, wherein selection is based on information of given user equipment with which the access request is associated.

28. The apparatus of claim 26, wherein selection is based on information of the service consumer that sent the access request.

29. The apparatus of claim 26, wherein selection is based on a processing load of the service producer.

30. The apparatus of claim 25, wherein the access token comprises each of the identifiers for the service producer instances that belong to the requested service producer set identifier to enable the service consumer to perform a selection.

31. The apparatus of claim 25, wherein the access token specifies the identifiers for identified ones of the service producer instances that belong to the requested service producer set identifier in an audience claim field of the access token.

32. The apparatus of claim 25, wherein the service consumer is a network function (NF) and the authorization server function is a network repository function (NRF) in a 5G System.

33. A method comprising:
receiving a request from a service consumer in a communication system for access to a service type, wherein the request comprises information including a service producer set identifier;
determining whether the service consumer is authorized to access the service type;
identifying service producer instances that belong to the requested service producer set identifier;
generating an access token that comprises identifiers for identified ones of the service producer instances that belong to the requested service producer set identifier; and
sending the access token to the service consumer;
wherein the steps of the method are performed by an authorization server function in the communication system.

34. The method of claim 33, further comprising selecting a subset of identified ones of the service producer instances that belong to the requested service producer set identifier for inclusion in the access token.

35. The method of claim 34, wherein selection is based on information of given user equipment with which the access request is associated.

36. The method of claim 34, wherein selection is based on information of the service consumer that sent the access request.

37. The method of claim 33, wherein the access token comprises each of the identifiers for the service producer instances that belong to the requested service producer set identifier to enable the service consumer to perform a selection.

38. Apparatus comprising:
at least one processor;
at least one memory including computer program code;
the at least one memory and the computer program code being configured to, with the at least one processor, cause the apparatus at least to:
send a request to an authorization server function in a communication system for access to a service type, wherein the request comprises information including a service producer set identifier;
receive an access token that comprises identifiers for identified ones of service producer instances that belong to the requested service producer set identifier; and
use the access token to access one of the service producer instances identified in the access token;
wherein the at least one processor, the at least one memory and the computer program code are part of a service consumer in the communication system.

39. The apparatus of claim 38, wherein the access token comprises identifiers for each of the service producer instances that belong to the requested service producer set identifier.

40. The apparatus of claim 38, wherein the access token comprises identifiers for a subset of the service producer instances that belong to the requested service producer set identifier, wherein the subset was preselected by the authorization server function.

41. The apparatus of claim 38, wherein the access token specifies the identifiers for identified ones of the service producer instances that belong to the requested service producer set identifier in an audience claim field of the access token.

42. The apparatus of claim 38, wherein the service consumer is a network function (NF) and the authorization server function is a network repository function (NRF) in a 5G System.

43. A method comprising:
sending a request to an authorization server function in a communication system for access to a service type, wherein the request comprises information including a service producer set identifier;
receiving an access token that comprises identifiers for identified ones of service producer instances that belong to the requested service producer set identifier; and
using the access token to access one of the service producer instances identified in the access token;
wherein the steps of the method are performed by a service consumer of the communication system.

44. The method of claim 43, wherein the access token comprises identifiers for each of the service producer instances that belong to the requested service producer set identifier.
